(19) United States
(12) Patent Application Publication
(10) Pub. No.: US 2009/0028774 A1
(43) Pub. Date: Jan. 29, 2009

(54) CARBONATOR AND METHOD FOR MAKING CALCIUM CARBONATE

(76) Inventor: Rodrigo Matsushita, Sao Paulo (BR)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/282,208

(22) PCT Filed: Apr. 30, 2007
(86) PCT No.: PCT/US07/10424

§ 371 Date: Sep. 9, 2008

(30) Foreign Application Priority Data
May 4, 2006 (BR) PI-0601717-7

(51) Int. Cl. C01F 11/18; B01J 19/00; B01J 19/18

(52) U.S. Cl. 423/432; 422/129; 422/225

(57) ABSTRACT

The present invention provides a method for making precipitated calcium carbonate (PCC) which compensates for the slow reaction time of carbonation in a manner which reduces or eliminates the undesirable use and expense of added equipment and processes of previously known methods. The method of the invention involves the generation of multiple streams (preferably at least twenty-five streams) of carbon dioxide which are co-currently introduced to a flow of calcium hydroxide slurry (lime milk). By use of multiple gas streams an intimate mixing of carbon dioxide with the slurry is achieved which compensates for the slow reaction time of carbonation while reducing or eliminating the need for equipment and processes related to recycling, batch operation, serial operation, and long reactor length. An additional benefit of using multiple gas streams in co-current flow is a lower concentration gradient of PCC formed therein facilitating the formation of smaller particles. Furthermore, during the generation of multiple streams of carbon dioxide, the method of the present invention generates streams of carbon dioxide bubbles having a small diameter size which cumulatively contribute to the aforementioned benefits of the invention resulting from the intimate mixing of carbon dioxide and calcium hydroxide slurry.

### FIELD OF THE INVENTION

The present invention related to an apparatus and a method for the manufacture of precipitated calcium carbonate. In particular, the present invention relates to a carbonator and use thereof for the manufacture of calcium carbonate.

### BACKGROUND OF THE INVENTION

Precipitated calcium carbonate (PCC) is an additive in many industrial products such as healthcare products, paint, rubber, paper, plastics, adhesives, sealants, and a variety of other products. Methods for the manufacture of PCC involves “carbonation” which is the slow reaction of calcium hydroxide with carbon dioxide to precipitate CaCO₃ as expressed by the formula: Ca(OH)₂+CO₂→CaCO₃. An aqueous suspension of calcium hydroxide is typically obtained by mixing water with quicklime (CaO) to form a slurry known as “lime milk.” This lime milk is introduced to an apparatus known as a “carbonator” wherein lime milk is contacted with carbon dioxide to produce PCC. Carbonation is a slow reaction partly because of the low solubility of the carbon dioxide in lime milk. The chief function of a carbonator is to provide a means of adequately and efficiently contacting lime milk with CO₂. An efficient carbonator should desirably address problems associated with the slow reaction time of carbonation.

One known type of carbonator is a tower provided with a countercurrent means whereby a stream of CO₂ passes upward against a downward slurry of lime milk. To compensate for the slow reaction time of carbonation, added equipment is required to either: 1) continually recycle slurry from the tower's bottom to the top, or 2) effect a batch operation.

Another known type of carbonator is continuously stirred tank reactor (CSTR) which relies upon a mechanical agitator and the introduction of CO₂ directly into the lime milk to effect carbonation. To compensate for the slow reaction time of carbonation, a cost prohibitively large reactor is required or multiple reactors in series must be employed.

Yet another known type of carbonator involves a plug flow reactor which is a long tubular vessel filled with a slurry of lime milk generally moving in a straight line direction into which a stream of carbon dioxide gas is introduced. To compensate for the slow reaction of carbonation, the plug flow reactor must be constructed of an undesirably costly long length.

All of the aforementioned carbonators use various means to compensate for the slow reaction time of carbonation which undesirably results in the use and expense of added equipment and processes. It would therefore be desirable to discover a method and carbonator for making precipitated calcium carbonate that reduces or eliminates the use and expense of added equipment and processes while also compensating for the slow reaction time of carbonation.

### BRIEF SUMMARY OF THE INVENTION

The present invention provides a method for making precipitated calcium carbonate (PCC) which compensates for the slow reaction time of carbonation in a manner which reduces or eliminates the undesirable use and expense of added equipment and processes of previously known methods. The method of the invention involves the generation of multiple streams (preferably at least twenty-five streams) of carbon dioxide which are co-currently introduced to a flow of calcium hydroxide slurry (lime milk).

By use of multiple gas streams an intimate mixing of carbon dioxide with the slurry is achieved which compensates for the slow reaction time of carbonation while reducing or eliminating the need for equipment and processes related to recycling, batch operation, serial operation, and long reactor length. An additional benefit of using multiple gas streams in co-current flow is a lower concentration gradient of PCC formed therein facilitating the formation of smaller particles.

The aforementioned benefits of the invention cannot be easily achieved with previously known types of carbonators such as towers, stirred tanks, or plug flow reactors. Furthermore, during the generation of multiple streams of carbon dioxide, the method of the present invention generates streams of carbon dioxide bubbles having a small diameter size, the average diameter thereof being no more than 10 cm. The small size of these bubbles cumulatively contribute to the aforementioned benefits of the invention resulting from the intimate mixing of carbon dioxide and calcium hydroxide slurry.

In particular, the present invention provides a method of producing precipitated calcium carbonate by a reaction between carbon dioxide gas and an aqueous slurry of calcium hydroxide, the method comprising the steps of: introducing, in a first direction, a flow of the slurry; deflecting, in a second direction, the flow of slurry into a reaction zone; generating multiple streams of carbon dioxide gas, preferably comprised of multiple streams of carbon dioxide bubbles having an average diameter of no more than 10 cm; directing the streams of gas, along the second direction, into the reaction zone such that the streams of gas and the flow of slurry share the same direction through the reaction zone for a predetermined amount of time, preferably at least 10 minutes, under conditions causing the precipitation of calcium carbonate; discharging and recovering the precipitated calcium carbonate.

The present invention also provides for a carbonator for containing a reaction between carbon dioxide gas and a slurry of calcium hydroxide to make a precipitated calcium carbonate product. The vessel comprises a closed outer housing having an inner surface thereon, the outer housing having formed therein: i) an aerator, the aerator comprising a plurality of gas inlets; and ii) a product outlet. The vessel further comprises a hollow core housing extending a predetermined distance into the outer housing, the core housing comprising: i) an outer surface thereon, ii) a slurry inlet port being defined at a first end of the core housing, and iii) a slurry outlet port being defined at a second end of the core housing. The inner surface of the outer housing and the outer surface of the core housing cooperate to define a reaction zone within the vessel. The aerator and the product outlet opening both communicate with the reaction zone. The aerator is located between the slurry outlet port and the product outlet opening. A deflector surface is disposed within the outer housing, the deflector surface being positioned in confrontational relationship with respect to the slurry outlet port, the deflector surface being operative such that a slurry emanating, in a first flow direction, from the slurry outlet port is deflected, in a second flow direction toward the product outlet opening, into the reaction zone wherein the slurry is able to react with gas being introduced along the second flow direction into the reaction zone from the aerator. The aerator preferably comprises at least twenty-five gas inlets. Optionally, the core housing comprises an agitator formed therein. The aerator preferably comprises gas inlets each having a diameter of no more 10 mm.

The aforementioned carbonator can be operated in the present invention by a method comprising the steps of: introducing, in a first direction, a flow of aqueous calcium hydroxide slurry into the slurry inlet port, through the core housing, and out of the slurry outlet port; deflecting, in a second direction toward the product outlet opening, the flow of slurry emanating from the slurry outlet port into the reaction zone; generating multiple streams of carbon dioxide gas emanating from the aerator, the streams of gas preferably comprising carbon dioxide bubbles having an average diameter of no more than 10 cm; directing the streams of gas, along the second direction, into the reaction zone such that the streams of gas and the flow of slurry share the same direction toward the product outlet opening through the reaction zone for a predetermined amount of time, preferably at least 10 minutes, under conditions causing the precipitation of calcium carbonate; and removing the precipitated calcium carbonate through the product outlet opening. Preferably, the multiple streams of carbon dioxide gas comprise at least twenty-five streams, more preferably at least fifty, and most preferably at least one-hundred. The method of the invention can further comprise agitating the slurry prior to deflecting.

### BRIEF DESCRIPTION OF THE DRAWINGS

FIG. 1 is a diagrammatic side sectional view of an exemplified carbonator of the invention.

FIG. 2 is a diagrammatic sectional view taken along view lines 2-2 in FIG. 1.

### DETAILED DESCRIPTION OF THE INVENTION

The present invention provides a method of producing precipitated calcium carbonate by a reaction between carbon dioxide gas and an aqueous slurry of calcium hydroxide, the method comprising the steps of: introducing, in a first direction, a flow of the slurry; deflecting, in a second direction, the flow of slurry into a reaction zone; generating multiple streams of carbon dioxide gas, preferably comprised of multiple streams of carbon dioxide bubbles having an average diameter of no more than 10 cm, more preferably no more than 5 cm, even more preferably no more than 3 cm, and most preferably no more than 1 cm; directing the streams of gas, along the second direction, into the reaction zone such that the streams of gas and the flow of slurry share the same direction through the reaction zone for a predetermined amount of time (preferably at least 10 minutes, more preferably at least 20 minutes, and most preferably at least 30 minutes) under conditions causing the precipitation of calcium carbonate; and discharging and recovering the precipitated calcium carbonate.

The predetermined amount of time (residence time) in the reactor zone, can be chosen based on desired PCC crystal formation produced therefrom with longer residence times producing thinner and smaller sized crystals. PCC crystals of different shapes and sizes are desired according to their application. For example, when used as additives in paint or paper, a small PCC crystal size is desirable.

The temperature of the calcium hydroxide slurry and carbon dioxide in the reaction zone is preferably maintained between 20° to 70° C. This reaction temperature may be varied according to the desired size, surface area, and crystalline structure of the PCC thereby obtained. Temperatures chosen below about 30° C. generally yield a product known as “calcite” comprising small sized particles (average diameter of about 0.02 to 0.10 nm) with a large surface area (about 18 to 70 m²/g) and having a rhombohedral crystal structure. Temperatures chosen above about 30° C. generally yield a product known as “aragonite” comprising relatively larger sized particles (average diameter of about 0.2 to 0.4 nm) with relatively smaller surface area (about 6 to 14 m²/g).

The amounts of calcium hydroxide and carbon dioxide added to the reaction zone are preferably chosen to maximize the conversion of calcium hydroxide to PCC given by the balanced chemical reaction: Ca(OH)₂+CO₂→CaCO₃. Generally, because of the low solubility of carbon dioxide in the calcium hydroxide slurry, carbon dioxide is the limiting reagent in the formation of PCC and the addition of a molar excess of carbon dioxide is preferred. Accordingly, the preferable amount of calcium hydroxide added to the reaction zone is such that 1 mole of calcium hydroxide is added for every 1 mole of PCC desired. The preferable amount of carbon dioxide added to the reaction zone is such that greater than 1 mole of carbon dioxide is added to every 1 mole of PCC desired. The amount of calcium hydroxide and carbon dioxide can be chosen according to their residence time in the reaction zone with lower residence times resulting in choosing fewer moles of calcium hydroxide and more moles of carbon dioxide added per 1 mole of PCC desired.

The aqueous slurry of calcium hydroxide added to the reaction zone preferably comprises 10 to 20 weight percent calcium hydroxide in water. The slurry can be made by mixing water with quicklime (CaO) in a process known as “hydration” which is represented by the following chemical reaction: CaO+H₂O→Ca(OH)₂. Hydration typically involves mixing quicklime with water in a hydrator at a reaction temperature of 20° to 70° C. and allowing to reaction for about 10 to 30 minutes, preferably 20 minutes. Reaction temperature can be varied to yield desired crystal formation and reaction time. In accordance with the invention, quicklime used during hydration should preferably have a CaO purity level of at least about 55 weight percent (preferably between 55-90%) and should have no more than about 1 weight percent of any metals such as iron, manganese, cobalt. Quicklime can be made by burning raw limestone (CaCO₃) to liberate carbon dioxide (CO₂) in a process known as “calcination” which is represented by the following chemical formula: CaCO₃+heat→Ca(OH)₂+CO₂. Calcination facilitates removal of impurities in the limestone and reduction of its grain size.

The carbon dioxide to the reaction zone is preferably of high purity because of the low solubility of the carbon dioxide in the calcium hydroxide slurry. Accordingly, the carbon dioxide should preferably have a purity level of at least 75 weight percent, more preferably at least 85 weight percent, and most preferably at least 95 weight percent.

A particularly suitable source of carbon dioxide in the present invention is obtained from the carbon dioxide waste stream of ethanol manufacturing process. Because the carbon dioxide waste stream comprises undesirable amounts of water and ethanol, the carbon dioxide waste stream is preferably sent to a compressor to be purified such that the water and ethanol is condensed and removed prior to use in the invention. To facilitate this purification the compressor should preferably have a discharge pressure of at least 1.0 bar (100 kPa).

In the present invention, recovery of the PCC product discharged from the reaction zone can be performed by a decanting and/or filtration step. In decanting, the discharged product is introduced to a settling tank. The discharged product, which comprises PCC and water, can be allowed to settle for a period of time (about 1 to 2 hours) effecting, by gravity, the settling of PCC at the bottom of the tank. Liquid can then be removed from the top of the tank leaving a decanted PCC product. This decanted product is sent to filtration equipment, such as a vacuum rotating filter, to remove any additional liquid. If further removal of liquid is desired, the decanted and/or filtered PCC product can be subjected to a drying step by using equipment such as a spray-dryer.

### EXAMPLES

### Example 1

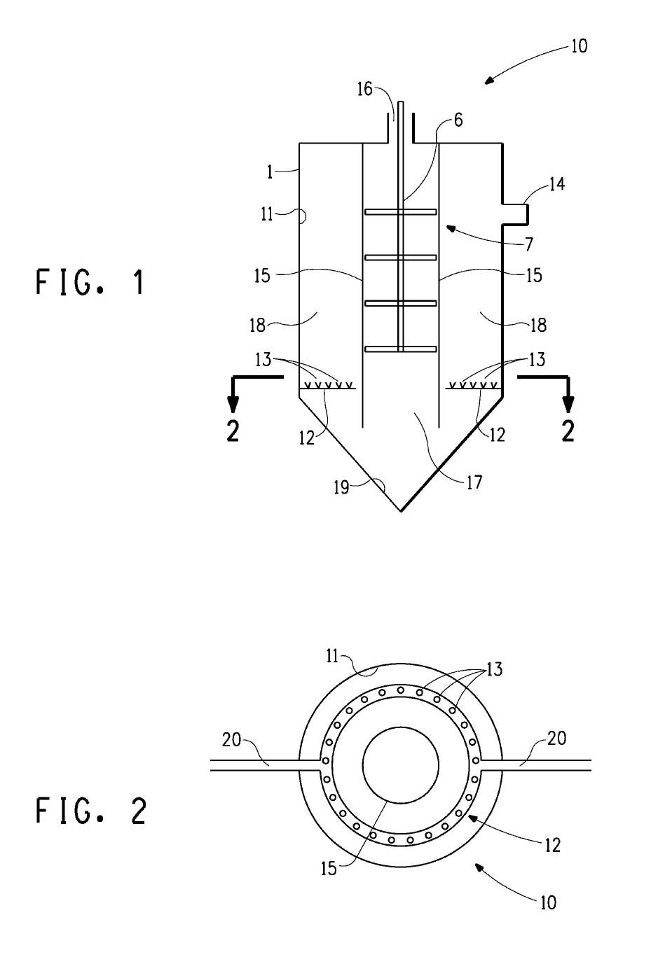

FIG. 1 is a diagrammatic side sectional view of an exemplified carbonator of the invention. Referring to FIG. 1, the carbonator of the present invention comprises a reactor vessel (10) for containing a reaction between carbon dioxide gas and a slurry of calcium hydroxide to make a precipitated calcium carbonate product. The vessel comprises a closed outer housing (1) having an inner surface thereon (11), the outer housing having formed therein: i) an aerator (12), the aerator comprising a plurality of gas inlets (13); and ii) a product outlet (14). The vessel further comprises a hollow core housing (7) extending a predetermined distance into the outer housing, the core housing comprising: i) an outer surface thereon (15), ii) a slurry inlet port (16) being defined at a first end of the core housing, and iii) a slurry outlet port (17) being defined at a second end of the core housing. The inner surface of the outer housing (11) and the outer surface of the core housing (15) cooperate to define a reaction zone (18) within the vessel. The aerator (12) and the product outlet opening (14) both communicate with the reaction zone (18). The aerator (12) is located between the slurry outlet port (17) and the product outlet opening (14). A deflector surface (19) is disposed within the outer housing (1), the deflector surface being positioned in confrontational relationship with respect to the slurry outlet port (17), the deflector surface being operative such that a slurry emanating, in a first flow direction, from the slurry outlet port is deflected, in a second flow direction toward the product outlet opening (14), into the reaction zone (18) wherein the slurry is able to react with gas being introduced along the second flow direction into the reaction zone from the aerator (12). The aerator (12) preferably comprises at least twenty-five gas inlets, preferably at least fifty, and most preferably at least one-hundred.

The aerator (12) preferably comprises gas inlets each having a diameter of no more than 10 mm, more preferably no more than 5 mm, still more preferably no more than 3 mm, and most preferably no more than 1 mm. The aerator (12) is preferably a ring which circumscribes the reaction zone (18). The carbonator of the present invention can further comprise an agitator (6) comprising a plurality of discs whose centers are attached to a rod.

FIG. 2 is a diagrammatic sectional view taken along view lines 2-2 in FIG. 1. The preferred placement of the aerator is further described in reference to FIG. 2 which shows the reactor vessel (10) having disposed therein the aerator (12) comprising a plurality of gas inlets (13) supplied with carbon dioxide gas through lines (20), the gas inlets forming a ring disposed between the outer surface of the core housing (15) and the inner surface of the outer housing (11).

### Example 2

In reference to FIG. 1, the present invention provides a method of producing precipitated calcium carbonate by a reaction between carbon dioxide gas and a slurry of calcium hydroxide, the reaction occurring in the reactor vessel (1) and comprises the steps of: introducing, in a first direction, a flow of the slurry into the slurry inlet port (16), through the core housing (7), and out of the slurry outlet port (17); deflecting, in a second direction toward the product outlet opening, the flow of slurry emanating from the slurry outlet port (17) into the reaction zone (18); generating multiple streams of carbon dioxide gas emanating from the aerator (12); directing the streams of gas, along the second direction, into the reaction zone (18) such that the streams of gas and the flow of slurry share the same direction toward the product outlet opening (14) through the reaction zone for a predetermined amount of time (preferably at least 10 minutes, more preferably at least 20 minutes, most preferably at least 30 minutes) under conditions causing the precipitation of calcium carbonate; and removing the precipitated calcium carbonate through the product outlet opening (14). Preferably, the multiple streams of carbon dioxide gas comprise at least twenty-five streams, more preferably at least fifty, and most preferably at least one-hundred. Preferably, the step of generating multiple streams of carbon dioxide gas further comprises generating streams of carbon dioxide bubbles having an average diameter of no more than 10 cm, preferably no more than 5 cm, even more preferably no more than 3 cm, and most preferably no more than 1 cm. The method of the invention can further comprise agitating the slurry prior to deflecting. Agitation can be performed by rotating the agitator (6) from 40 to 200 rpm.

It should be noted that the carbonator of the present invention can also be used in a sugar mill for the clarification of raw sugar. An advantage of using the carbonator of the invention in a sugar mill is that during operational inactivity for clarifying raw sugar, the carbonator can be used to make PCC.

What is claimed is:

1. A method of producing precipitated calcium carbonate by a reaction between carbon dioxide gas and an aqueous slurry of calcium hydroxide, the method comprising the steps of:
introducing, in a first direction, a flow of the slurry;
deflecting, in a second direction, the flow of slurry into a reaction zone;
generating multiple streams of carbon dioxide gas;
directing the streams of gas, along the second direction, into the reaction zone such that the streams of gas and the flow of slurry share the same direction through the reaction zone for a predetermined amount of time under conditions causing the precipitation of calcium carbonate; and
discharging and recovering the precipitated calcium carbonate.

2. The method of claim 1 wherein the multiple streams of carbon dioxide gas comprise at least twenty-five streams.

3. The method of claim 1 further comprising agitating the slurry prior to deflecting.

4. The method of claim 1 wherein the predetermined about of time is at least 10 minutes.

5. The method of claim 1 wherein the step of generating multiple streams of carbon dioxide gas further comprises generating streams of carbon dioxide bubbles having an average diameter of no more than 10 cm.

6. A reactor vessel for containing a reaction between carbon dioxide gas and a slurry of calcium hydroxide to make a precipitated calcium carbonate product, the vessel comprising:
a closed outer housing having an inner surface thereon, the outer housing having formed therein: i) an aerator, the aerator comprising a plurality of gas inlets; and ii) a product outlet;
a hollow core housing extending a predetermined distance into the outer housing, the core housing comprising: i) an outer surface thereon, ii) a slurry inlet port being defined at a first end of the core housing, and iii) a slurry outlet port being defined at a second end of the core housing;
the inner surface of the outer housing and the outer surface of the core housing cooperating to define a reaction zone within the vessel;
the aerator and the product outlet opening both communicating with the reaction zone, the aerator being located between the slurry outlet port and the product outlet opening; and
a deflector surface disposed within the outer housing, the deflector surface being positioned in confrontational relationship with respect to the slurry outlet port, the deflector surface being operative such that a slurry emanating, in a first flow direction, from the slurry outlet port is deflected, in a second flow direction toward the product outlet opening, into the reaction zone wherein slurry is able to react with gas being introduced along the second flow direction into the reaction zone from the aerator.

7. The reactor vessel of claim 6 wherein the aerator comprises at least twenty-five gas inlets.

8. The reactor vessel of claim 6 wherein the core housing comprises an agitator formed therein.

9. The reactor vessel of claim 6 wherein each of the gas inlets has a diameter of no more than 10 mm.

10. A method of producing precipitated calcium carbonate by a reaction between carbon dioxide gas and a slurry of calcium hydroxide, the reaction occurring in the reactor vessel of claim 6, the method comprising the steps of:
introducing, in a first direction, a flow of the slurry into the slurry inlet port, through the core housing, and out of the slurry outlet port;
deflecting, in a second direction toward the product outlet opening, the flow of slurry emanating from the slurry outlet port into the reaction zone;
generating multiple streams of carbon dioxide gas emanating from the aerator;
directing the streams of gas, along the second direction, into the reaction zone such that the streams of gas and the flow of slurry share the same direction through the reaction zone for a predetermined amount of time under conditions causing the precipitation of calcium carbonate; and
removing the precipitated calcium carbonate through the product outlet opening.

11. The method of claim 10 wherein the multiple streams of carbon dioxide gas comprise at least twenty-five streams.

12. The method of claim 10 further comprising agitating the slurry prior to deflecting.

13. The method of claim 10 wherein the predetermined about of time is at least 10 minutes.

14. The method of claim 10 wherein the step of generating multiple streams of carbon dioxide gas further comprises generating streams of carbon dioxide bubbles having an average diameter of no more than 10 cm.
